(19) United States
(12) Patent Application Publication
(10) Pub. No.: US 2005/0135706 A1
(43) Pub. Date: Jun. 23, 2005

(54) System and method for shadow imaging

(75) Inventors: Anandraj Sengupta, Bangalore (IN); Imdad Mohammad Basha, Bangalore (IN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/742,035

(22) Filed: Dec. 19, 2003

(51) Int. Cl. G06K 9/00

(52) U.S. Cl. 382/286

(57) ABSTRACT

A system for shadow imaging a sample comprises a heat source configured for heating a sample, at least one light source configured for casting light on the sample and at least one screen configured for receiving at least one shadow image. The system further comprises at least one imaging device configured for capturing the shadow image.

### BACKGROUND OF THE INVENTION

This invention relates to an imaging system and more particularly the system and method relates to shadow imaging.

In many applications, where a sample is subjected to heat, it is often difficult to determine the edges of the sample on being heated. In particular, edge detection presents a major challenge to accuracy and reliability in materials testing, for example in flammability tests of plastic materials and migration test of filamentous materials such as tungsten filaments.

An example of the flammability test is the UTL94 flame test, which requires amongst other test standards, closely tracking the distance between a burner and a plastic sample, detection of an ‘about-to-drip condition’ during exposure of the test sample to the flame, and subsequent displacement of the burner from under the plastic sample to prevent contamination of the flame. Typically, these test parameters are detected by and responded to using visual and manual methods. For example, an operator frequently observes the sample burning and tracks the distance between the burner and the sample by observing the flame and plastic sample and visually gauging the distance between the two.

One disadvantage of the above-described visual and manual method is that it is difficult for the operator to visually detect the edge of the sample. The strong light emitted by the sample as it is exposed to the flame makes it extremely difficult to detect the edges of the sample. Moreover, manual test methods are inherently subject to operator idiosyncrasy and are frequently more costly than automated test methods.

Therefore, there is a need in applications such as in flammability testing to provide a means of edge detection, which is both reliable and may be readily automated.

### BRIEF SUMMARY OF THE INVENTION

In one aspect, the invention provides a system for shadow imaging a sample, the system comprising a heat source configured for heating a sample, and at least one light source configured for casting light on the sample. The system further comprises at least one screen configured for receiving at least one shadow image and at least one imaging device configured for capturing the shadow image.

In another aspect, the invention relates to a method for detecting edges of a sample. The method comprises irradiating a heat source and a sample with at least one light source to generate at least one shadow image and processing the shadow image to obtain a plurality of parameters which may be used to detect in real time the position of at least one sample edge.

In a further embodiment of the invention, a flame test apparatus for characterizing a sample based on a plurality of flammability properties is provided. The apparatus comprises a burner configured for heating a sample and at least one light source configured for casting light on the sample. The apparatus further comprises at least one screen configured for receiving at least one shadow image of the sample and at least one imaging device configured for capturing the shadow image.

### BRIEF DESCRIPTION OF THE DRAWINGS

FIG. 1 represents a flow chart illustrating an aspect of the invention which provides a method for generating a shadow image of a test sample, said method comprising controlling the relative positions in space of a heat source and the test sample.

FIG. 2 represents an aspect of the invention which is a system for detecting the edges of a test sample.

FIG. 3 illustrates an embodiment of the invention comprising multiple light sources and multiple shadow images.

### DETAILED DESCRIPTION OF THE INVENTION

The invention may be understood more readily by reference to the following detailed description of embodiments of the invention and the examples included herein. In this specification and in the claims which follow, reference will be made to a number of terms which shall be defined to have the following meanings.

The singular forms “a”, “an” and “the” include plural referents unless the context clearly dictates otherwise. As used herein, “adapted to”, and “configured” refer to mechanical or structural connections between elements to allow the elements to cooperate to provide a described effect; these terms also refer to operation capabilities of electronic elements, and application specific devices that are programmed to provide an output in response to at least one input signal.

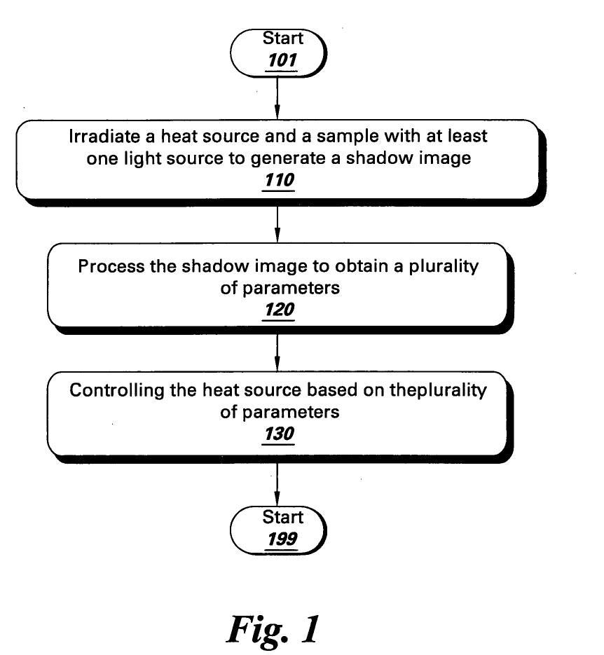

In one aspect the invention relates to a method for detecting edges of a sample while the sample is being subjected to heating. FIG. 1 is a flow chart illustrating the various steps of the method for detecting edges of the sample. Each step is described in detail below.

In step 110, a heat source and the sample are irradiated with at least one light source to generate at least one shadow image. In one embodiment of the method of the invention, two light sources are used to generate two shadow images. The shadow image may comprise a shadow image of the sample alone, or a shadow image of the sample together with the shadow image of at least one other object, for example a shadow image of the heat source or the shadow image of a reference object. For convenience, it is helpful to refer to these components of the shadow image as “the sample shadow”, “the heat source shadow”, “the reference object shadow”, and the like. Typically, the shadow image is projected upon a flat surface, for example an opaque sheet of paper or a slide projection screen. The shadow image cast upon the flat surface may be analyzed by a human observer, or the shadow image on the flat surface may be first captured as a digital image by means such as a digital camera and then analyzed by means such as a computer capable of correlating the digital image of the sample with the physical parameters of the sample, for example the dimensions of the sample, the distance between an edge of the sample and the heat source, and like parameters. The sample used according to the method of the invention is not particularly limited and may, for example, comprise glass, metal, wood, paper, ceramic materials, and mixtures thereof. Notwithstanding its applicability to a huge variety of sample compositions, the method is particularly well suited to the evaluation of samples comprising plastic materials. Thus in a specific embodiment of the invention, the sample comprises at least one plastic material. Examples of plastic materials include polymeric materials which are considered “homopolymers” such as bisphenol A polycarbonate; polymeric materials which are considered “copolymers” such as the polyester carbonates illustrated in U.S. Pat. No. 6,600,004; polymeric materials which are considered blends such as a blend comprising poly(2,6-dimethyl-1,4-phenylene oxide) and polystyrene; and composite materials such as a plastic material comprising a both thermoplastic material one or more components selected from the group consisting of clays, organo-clays, glass fibers, carbon fibers, carbon fibrils, and carbon nanotubes. It will be appreciated by those skilled in the art that the sample being evaluated may comprise various additives, such as flame retardants, UV stabilizers, thermal stabilizers, inorganic fillers, coloring agents, and the like. Although the samples analyzed according to the method of the invention are frequently opaque (with respect to a human observer), they need not be, and any sample capable of affording any shadow image which may be captured and analyzed is suitable. In one embodiment of the method of the invention the sample is translucent.

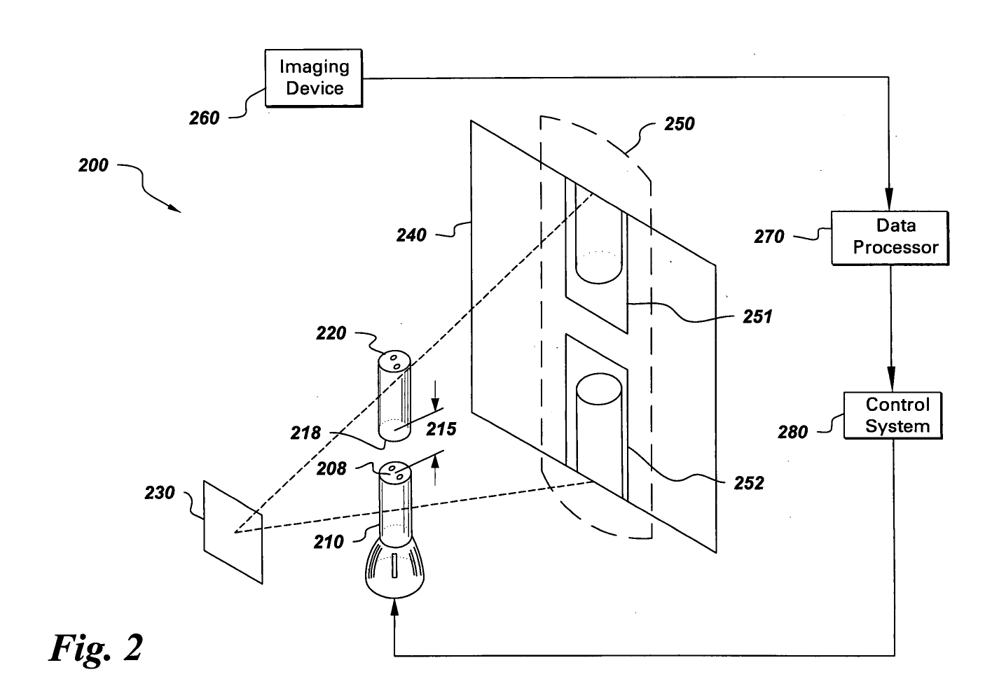

Referring to FIG. 1, in step 120, the shadow image is processed to obtain a plurality of sample parameters. Examples of the sample parameters include, dimensions of the sample and a distance between the heat source and the sample. In one embodiment, the shadow image may be observed by an operator to determine the distance between the heat source and the sample. In another embodiment, the shadow image is a machine-readable image and may be processed using image processing techniques to obtain one or all of the parameters. In one embodiment, the shadow image is processed using a thresholding technique. The thresholding technique typically includes converting a first gray scale image (for example, a shadow image) comprising multiple pixels with corresponding intensity values to a second image, the “thresholded” image, the “thresholded” image comprising fewer intensity values than the first gray scale image. Typically, the gray scale image is thresholded at a pre-determined intensity value. For example, by applying the thresholding technique on the shadow image, all pixels having an intensity value of greater than the pre-determined value appear as white and all pixels having an intensity value of less than the pre-determined value appear as black in the “thresholded” image. The thresholded image may comprise a sample shadow, a heat source shadow, a reference object shadow, or a combination thereof, said shadows having enhanced sharpness, as the shadows will be of a different intensity value than the background. In a specific embodiment, the pre-determined intensity value is about 105 in a range of 0 to 255 gray values. The plurality of parameters is then determined by using arithmetical or logical operations on the thresholded image. Still referring to FIG. 1, in step 130, the heat source is controlled based on a change in at least one of the plurality of sample parameters. In one embodiment, the heat source is controlled based on a change in the distance between the heat source and the sample. In one embodiment, the distance is defined by the distance between a lower point of the sample and the center point of the burner. In a further embodiment, the distance is controlled by moving the heat source in three directions with respect to the sample, that is, moving the heat source in the horizontally, vertically or by rotation. For example, if the distance between the heat source and the sample is less than desired distance, the heat source can be controlled to move away from the sample. In another embodiment, the heat source is controlled based on the physical dimensions of the sample. In a specific embodiment, the controlling occurs in real time.. For example, if the sample melts due to the heat generated by the heat source and is about to drip on to the heat source, the heat source can be tilted to an angle, so as to avoid contact between the melting sample and the heat source which can potentially damage or destroy the heat source object. FIG. 2 illustrates one embodiment of a system 200 implemented in accordance with the method of FIG. 1. System 200 comprises heat source 210, sample 220, light source 230 and screen 240. Each component is described in further detail below.

Heat source 210 is configured for heating sample 220. Examples of heat source 210 include a flame, a burner, an arc and a filament. The distance between the heat source and the sample is represented by reference numeral 215. In one embodiment, distance is calculated between the lower point 218 of the sample and the burner 210.

Light source 230 is configured for casting light on the sample. In the illustrated embodiment, a single light source is used for casting light on the sample. In other embodiments, a plurality of light sources is used. Examples of light sources include electric bulb, flashlights, halogen lights, etc. In one embodiment, the light source has a straight filament and the light source is positioned such that the axis of the filament when extended passes through a center of mass of the sample.

Screen 240 is configured for receiving at least one shadow image. The screen is placed at a pre-determined distance from the heat source as shown in FIG. 2. Examples of screens include a whiteboard, a flat surface wall, a cloth screen, etc. In one embodiment, the shadow image comprises a sample shadow 251 and a heat source shadow 252. In another embodiment, a plurality of shadow images is cast on screen 240.

Imaging device 260 is configured for capturing the shadow image from screen 240. In one embodiment, a single imaging device is used. In another embodiment, a plurality of imaging devices is used. Examples of imaging devices include digital cameras, and close circuit devices.

Data processor 270 is configured for processing the shadow image to determine a plurality of parameters. Examples of the plurality of parameters include a dimension of the sample and the distance 215 between the heat source and the sample.

Control system 280 is configured to control the distance between the heat source and the sample. In one embodiment, the control system is configured to provide instructions to an automated system (such as a robotic arm), to move the heat source in a desired direction. In one embodiment, the distance 215 is calculated by the processor by comparing with a pre-determined distance. When distance 215 is different from the pre-determined distance, the processor instructs the control system to control the distance as desired. For example, if the distance 215 is less than the pre-determined distance, the control system moves the heat source away from the sample.

System 200 as illustrated may be used for various applications. Examples of such application include a flame test apparatus and a migration test apparatus for filaments. The description is continued with reference to a flame test apparatus implemented in accordance with the invention.

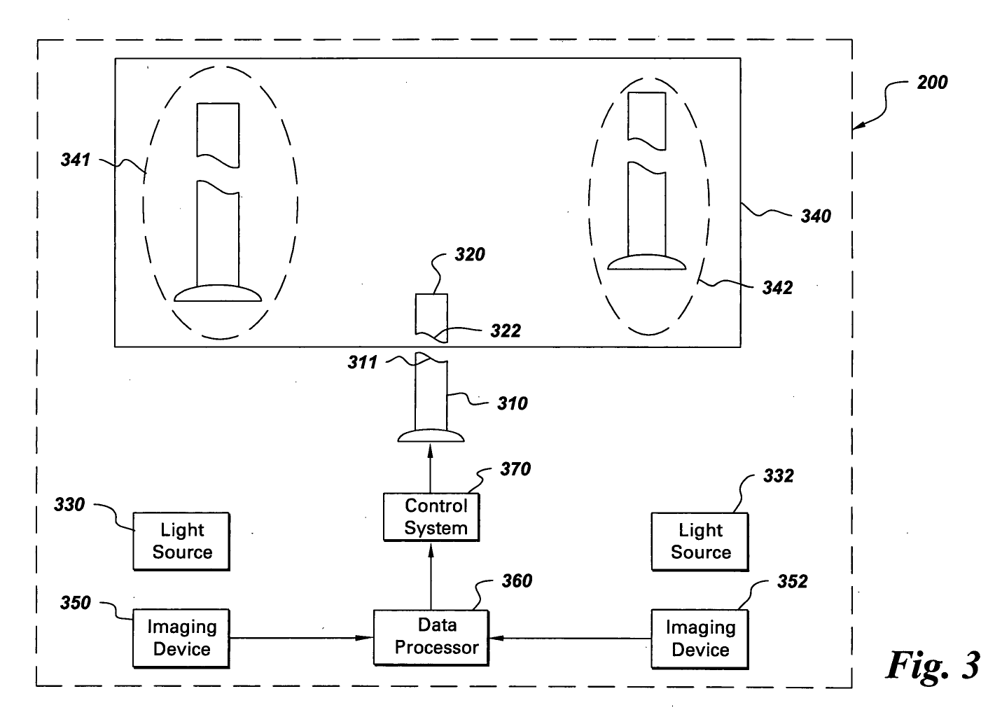

FIG. 3 illustrates an embodiment of a flame test apparatus 300 for classifying a sample based on a plurality of sample and flame properties. The flame test apparatus comprises a burner, light sources, screen, imaging devices, data processor and control system. Each component is described in further detail below.

Burner 310 configured for heating sample 320. In one embodiment, the sample burns and is classified based on a plurality of flame properties. In the illustrated embodiment, it is required to align point 311 of the burner and the lowest point of the sample 322 in a straight line. In the illustrated embodiment, the sample comprises a plastic.

Light sources 330 and 332 are configured for casting light on the sample. In the illustrated embodiment, the light sources are light bulbs. Screen 340 is configured for receiving the shadow images 341 and 342 generated by light sources 332 and 330 respectively. In one embodiment, an operator (not shown) observes the shadow image and manually controls a distance between the burner 310 and the sample 320.

Imaging device 350 and 352 are configured for capturing the shadow image. The images thus captured are provided to data processor 360. Data processor 360 is configured for processing the shadow image to determine a plurality of parameters. The processing of the shadow image may be performed using any well known image processing technique such as known image thresholding methods and the like.

The plurality of parameters can be determined using various mathematical and logical operations. Examples of the plurality of parameters include a dimension of the sample and the distance between the burner and the sample.

Control system 370 receives signals based on the distance from processor 360 and is configured to control the burner based on a change in the distance. In one embodiment, the burner flame is controlled with respect to methane flow rate and air-fuel ratio. In the illustrated embodiment, the distance between point 311 of the burner which is the “center point” part of the burner closest to the sample, and the “lowest” point of the sample closest to the burner 322 is 10 millimeters.

In one embodiment, the flame test apparatus of the invention may be used to conduct UL94 vertical flame tests. Samples employed in such tests are typically plastic materials. In one embodiment, the method, apparatus and system of the invention are used to carry out UL94 vertical flame tests on samples comprising bisphenol-A polycarbonate, for example LEXAN polycarbonate, and CYCOLOY. LEXAN and CYCOLOY are products of GE Plastics and are commercially available. Typically the samples employed according to the method of the invention are molded parts. In a specific embodiment, the samples are molded test parts having dimensions of about 125 mm×13 mm×3 mm. With respect to a typical human visual observer, the sample may be opaque, transparent or translucent.

In one embodiment in which the invention is used to carry out the UL94 test, the heat source is a conventional Bunsen burner. The burner is held on a 3-axis robotic arm driven by stepper motors. The Bunsen burner may be moved relative to the sample in any direction, up, down and sideways, with respect to the position in space of the sample.

In a specific embodiment in which the invention is used to conduct the UL94 flame test, two halogen light sources are used. The light sources are positioned about 500 millimeters from the sample and the burner. The distance between the two halogen light sources is about 500 millimeters. A whiteboard screen having dimensions about 1000 mm×600 mm is used for receiving the shadow image. The whiteboard screen is placed on the opposite side of the burner as the light, so as to cast a shadow. The screen is placed at about 150 mm from the sample. Two cameras are used to capture a photographic image of the shadow image on the screen. The photographic image comprises a portion of the shadows cast by the burner and the sample. Using the photographic images obtained from two cameras a data processor is used to compute the distance between the lowest point of the sample and the center point of the burner in real-time and in three dimensions.

In a further embodiment, the data processor is also configured to compute an error vector. The error vector can be used it to control the robotic arm such that the center point of the burner is always positioned directly under the lowest point of the sample at a separation of 10 millimeters within a limit of plus or minus 1 millimeter. The invention described above can be used to control the distance between the sample and the burner.

In a particular embodiment the invention provides a system for shadow imaging a sample. The system comprises a heat source comprising a flame for heating a plastic sample and two light sources configured for casting light on the sample. The system further comprises one screen configured for receiving two shadow images and two imaging devices configured for capturing the shadow images. The system also comprises a data processor configured for processing the shadow images to determine a plurality of parameters and a control system configured to control a distance between the heat source and the sample. The plurality of parameters includes a dimension of the sample. The control system is coupled to an automated means to control the distance between the heat source and the sample.

In a specific embodiment, a method for detecting edges of a sample is provided. The method comprises irradiating a heat source comprising a flame and a plastic sample with two light sources to generate two shadow images. The method further comprises projecting the shadow images on one screen and imaging each of the shadow images appearing on the screen using two imaging devices to provide at least one machine readable image. The method further comprises processing the machine-readable image to obtain a plurality of parameters and controlling a relative position of the heat source with respect to the plastic sample.

The advantages of the invention include an accurate, real time control of a position of the heat source with respect to the heat source.. The edges of the sample are more clearly visible as the flame is not captured as a shadow while implementing the shadow imaging technique described above.

The invention has been described in detail with particular reference to preferred embodiments thereof, but it will be understood by those skilled in the art that variations and modifications can be effected within the spirit and scope of the invention.

1. A system for shadow imaging a sample, the system comprising:
(a) a heat source configured for heating a sample;
(b) at least one light source configured for casting light on the sample;
(c) at least one screen configured for receiving at least one shadow image; and
(d) at least one imaging device configured for capturing the shadow image.

2. The system of claim 1, wherein the at least one shadow image comprises a sample shadow and a heat source shadow.

3. The system of claim 1, further comprising a data processor configured for processing the shadow image to determine a plurality of parameters.

4. The system of claim 3, wherein the plurality of parameters include a dimension of the sample.

5. The system of claim 3, wherein the plurality of parameters include a distance between the heat source and the sample.

6. The system of claim 5, further comprising a control system configured to control the distance between the heat source and the sample.

7. The system of claim 1, wherein the heat source is a flame.

8. The system of claim 1, wherein the sample is transparent or translucent.

9. The system of claim 1, wherein the sample is a plastic.

10. The system of claim 1, wherein the system is a flame test apparatus.

11. The system of claim 1, wherein the system is a migration test apparatus for filaments.

12. A method for detecting edges of a sample, said method comprising
(a) irradiating a heat source and a sample with at least one light source to generate at least one shadow image; and
(b) processing the shadow image to obtain a plurality of parameters.

13. The method of claim 12, wherein said shadow image is a machine readable image.

14. The method of claim 12, wherein the at least one shadow image comprises a sample shadow and a heat source shadow.

15. The method of claim 12, wherein the plurality of parameters includes a dimension of the sample.

16. The method of claim 12, wherein the plurality of parameters includes a distance between the heat source and the sample.

17. The method of claim 12, further comprising controlling the heat source based on a change in the distance.

18. The method of claim 17, wherein the controlling occurs real-time.

19. The method of claim 12, wherein the heat source is a burner, wherein the burner is configured to produce a flame when operational.

20. The method of claim 12, wherein the sample is transparent or translucent.

21. The method of claim 12, wherein the sample is a plastic.

22. The method of claim 12, wherein the method is a flame test apparatus.

23. The method of claim 12, wherein the method is a migration test apparatus for filaments.

24. A flame test apparatus for classifying a sample based on a plurality of flame properties, the apparatus comprising:
(a) a burner configured for heating a sample;
(b) at least one light source configured for casting light on the sample;
(c) at least one screen configured for receiving at least one shadow image of the sample; and
(d) at least one imaging device configured for capturing the shadow image.

25. The apparatus of claim 24, wherein the at least one shadow image comprises a sample shadow and a burner shadow.

26. The apparatus of claim 24, further comprising an operator for manually controlling a distance between the burner and the sample by observing the shadow image.

27. The apparatus of claim 24, further comprising a data processor configured for processing the shadow image to determine a plurality of parameters.

28. The apparatus of claim 27, wherein the plurality of parameters include a dimension of the sample.

29. The apparatus of claim 27, wherein the plurality of parameters include the distance between the burner and the sample.

30. The apparatus of claim 27, further comprising a control system configured to control the burner based on a change in the distance.

31. The apparatus of claim 24, wherein the sample is transparent or translucent.

32. The apparatus of claim 24, wherein the sample is a plastic.

33. The apparatus of claim 24, wherein the flame test apparatus is a UL94 vertical flame test apparatus.

34. A system for flame testing, said system comprising:
(a) a heat source comprising a flame for heating a plastic sample;
(b) two light sources configured for casting light on the sample;
(c) one screen configured for receiving two shadow images;
(d) two imaging devices configured for capturing the shadow images;
(e) a data processor configured for processing the shadow images to determine a plurality of parameters; and
(f) a control system configured to control a distance between the heat source and the sample.

35. The system of claim 34, wherein the plurality of parameters include a dimension of the sample.

36. The system of claim 34, wherein the control system is coupled to an automated means to control the distance between the heat source and the sample.

37. A method for flame testing, said method comprising;
(a) irradiating a heat source comprising a flame and a plastic sample with two light sources to generate two shadow images;
(b) projecting the shadow images on one screen;
(c) imaging each of the shadow images appearing on the screen using two imaging devices to provide at least one machine readable image;
(d) processing the machine readable image to obtain a plurality of parameters; and
(e) controlling a relative position of the heat source with respect to the plastic sample.
